(19) United States
(12) Patent Application Publication
(10) Pub. No.: US 2008/0187132 A1
(43) Pub. Date: Aug. 7, 2008

(54) Apparatus for encryption and method using the same

(75) Inventors: Maeng Hee Sung, Seoul (KR); Tae-Chul Jung, Seongnam-si (KR); Weon Il Jin, Suwon-si (KR); Heejean Kim, Yongin-si (KR); Baeeun Jung, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/907,199

(22) Filed: Oct. 10, 2007

(30) Foreign Application Priority Data
Feb. 2, 2007 (KR) 10-2007-0010973

(51) Int. Cl. H04L 9/28

(52) U.S. Cl. 380/28

(57) ABSTRACT

An encryption apparatus and method is provided. The encryption apparatus includes a first block cipher which block-encrypts an N-bit input into an M-bit output in which M is greater than N; a parallel processor which divides the M-bit output into at least two N-bit inputs, and block-encrypts each of the N-bit inputs into each of M-bit outputs by a parallel process which uses second block ciphers corresponding to a number of the divided N-bit inputs; and a converter which converts a plaintext into a ciphertext based on the block-encrypted M-bit output.

### CROSS-REFERENCE TO RELATED APPLICATION

This application claims benefit under 35 U.S.C. § 119(a) of Korean Patent Application No. 10-2007-0010973, filed on Feb. 2, 2007, in the Korean Intellectual Property Office, the entire disclosure of which is hereby incorporated by reference.

### BACKGROUND OF THE INVENTION

1. Field of the Invention

The present invention relates to a method and apparatus for encryption. More particularly, the present invention relates to an encryption apparatus and method which can perform a parallel process of a block cipher having an output length greater than an input length.

2. Description of Related Art

Encryption technology is typically used for securing the safety of message transmission. According to the encryption technology, a transmitting side encrypts a plaintext and a receiving side decrypts a ciphertext. Encryption of the plaintext and decryption of the ciphertext are well-known in the encryption technology.

A data encryption standard (DES) is a block-unit encryption protocol selected as a standard in several countries and by American National Standards Institute (ANSI). Also, other encryption protocols include a triple DES, an advanced encryption standard (AES), and the like. The block-unit encryption protocol defines various operation modes, specifically, electronic codebook (ECB), cipher block chaining (CBC), output feedback (OFB), cipher feedback (CFB), and the like.

An encryption apparatus uses, for data security in a data network, a block cipher and various operation modes performing actual encryption using the block cipher.

However, a conventional encryption apparatus includes only a method with respect to an encryption algorithm in which an input length and an output length are equal, and excludes a method with respect to an encryption algorithm having an output length greater than an input length.

Accordingly, there is a need for an improved apparatus which can efficiently process the encryption algorithm having the output length greater than the input length is required.

### SUMMARY OF THE INVENTION

Exemplary embodiments of the present invention address at least the above problems and/or disadvantages and provide at least the advantages described below. Accordingly, an aspect of exemplary embodiments of the present invention provides an encryption apparatus and method which can efficiently process an encryption algorithm having an output length greater than an input length.

Another aspect of exemplary embodiments of the present invention provides an encryption apparatus and method which can perform a parallel process of a ciphertext and improve encryption speed.

According to an aspect of exemplary embodiments of the present invention, there is provided an encryption apparatus including a first block cipher which block-encrypts an N-bit input into an M-bit output in which M is greater than N; a parallel processor which divides the M-bit output into at least two N-bit inputs, and block-encrypts each of the N-bit inputs into each of M-bit outputs by a parallel process which uses second block ciphers corresponding to a number of the divided N-bit inputs; and a converter which converts plaintext into a ciphertext based on the block-encrypted M-bit output.

In an aspect of exemplary embodiments of the present invention, the parallel processor includes an input divider which divides the M-bit output into the N-bit inputs; and an encrypter which block-encrypts each of the N-bit inputs into each of M-bit outputs by the parallel process for using the second block ciphers.

In an aspect of exemplary embodiments of the present invention, an M-bit output length of the block cipher corresponds to a multiple of an N-bit input length, or is different from the multiple of the N-bit input length.

In an aspect of exemplary embodiments of the present invention, the parallel processor processes the M-bit output length into the multiple of the N-bit input length by using a padding method.

In an aspect of exemplary embodiments of the present invention, the parallel processor divides the N-bit input processed by the padding method into any one of the second block ciphers.

In an aspect of exemplary embodiments of the present invention, the first block cipher receives an N-bit initialization vector and block-encrypts the initialization vector into the M-bit output.

In an aspect of exemplary embodiments of the present invention, the encryption apparatus is operated in an output feedback (OFB) mode.

According to another aspect of exemplary embodiments of the present invention, there is provided an encryption method including block-encrypting, by a first block cipher, an N-bit input into an M-bit output in which M is greater than N; dividing the M-bit output into at least two N-bit inputs; block-encrypting each of the N-bit inputs into each of M-bit outputs by a parallel process which uses second block ciphers corresponding to a number of the divided N-bit inputs; and converting a plaintext into a ciphertext based on the block-encrypted M-bit output.

In an aspect of exemplary embodiments of the present invention, the dividing processes the M-bit output length into the multiple of the N-bit input length by using a padding method.

### BRIEF DESCRIPTION OF THE DRAWINGS

The above and other aspects, features, and advantages of certain embodiments of the present invention will be more apparent and more readily appreciated from the following detailed description taken in conjunction with the accompanying drawings of which:

FIG. 1 is a block diagram illustrating a configuration of an encryption apparatus according to an exemplary embodiment of the present invention;

FIG. 2 is a block diagram illustrating a detailed configuration according to an exemplary embodiment of a repetition processor of FIG. 1;

FIG. 3 is a block diagram illustrating a detailed configuration according to another exemplary embodiment of a repetition processor of FIG. 1;

FIG. 4 is a flowchart illustrating operations of an encryption method according to an exemplary embodiment of the present invention; and

FIG. 5 is a flowchart illustrating operation S420 of FIG. 4 in detail according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness

Exemplary embodiments of the present invention are described below by referring to the figures.

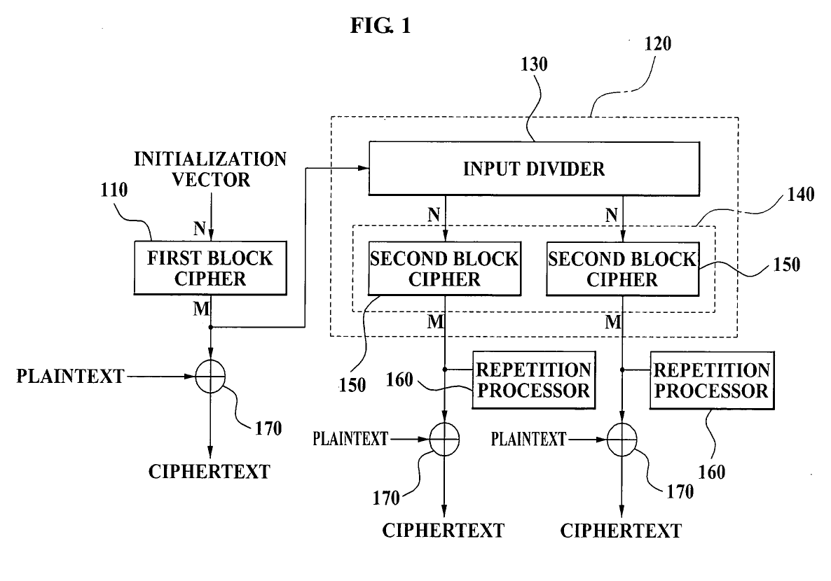

FIG. 1 is a block diagram illustrating a configuration of an encryption apparatus according to an exemplary embodiment of the present invention.

Referring to FIG. 1, the encryption apparatus includes a first block cipher 110, a parallel processor 120, repetition processors 160, and converters 170.

The first block cipher 110 block-encrypts an initialization vector of an N-bit input into an M-bit output in which M is greater than N. In this instance, the converter 170 converts a plaintext into a ciphertext based on the M-bit output block-encrypted by the first block cipher 110.

The parallel processor 120 divides the M-bit output block-encrypted by the first block cipher 110 into N-bit inputs, and block-encrypts each of the divided N-bit inputs into each of M-bit outputs by a parallel process which uses second block ciphers 150.

The parallel processor 120 includes an input divider 130 and an encrypter 140.

The input divider 130 divides the M-bit output block-encrypted by the first block cipher 110 into the N-bit inputs.

In this instance, the input divider 130 divides the M-bit output into the N-bit inputs corresponding to a multiple of an N-bit input length when an M-bit output length corresponds to the multiple of the N-bit input length.

In this instance, the input divider 130 divides the M-bit output into the N-bit inputs by using a padding method when the M-bit output length is different from the multiple of the N-bit input length.

Here, the padding method corresponds to an exemplary embodiment of padding an equal number of bytes as a number of deficient bytes and performing encryption when performing block-unit encryption.

Specifically, since bits remaining after dividing the M-bit output into the N-bit inputs is different from an N-bit when the M-bit output length is different from the multiple of the N-bit input length, the input divider 130 generates the remaining bits into the N-bit input by using the padding method. For example, when the N-bit input length is 128-bits, and the M-bit output length is 320-bits, the 320-bit length becomes two 128-bit lengths and 64-bit length. Accordingly, the input divider 130 uses the padding method in order to generate a padding of 64-bits to pad the remaining 64-bits, and thereby generating 128-bits.

The encrypter 140 includes the second block ciphers 150.

Each of the second block ciphers 150 block-encrypts each of the N-bit inputs divided by the input divider 130 into each of M-bit outputs.

In this instance, the second block cipher 150 may be same as the first block cipher 110.

Each of the converters 170 converts the plaintext into the ciphertext based on the M-bit output block-encrypted by the first block cipher 110 or the parallel processor 120.

Each of the repetition processors 160 sequentially repeatedly performs a process of block-encrypting each of the N-bit inputs into each of M-bit outputs, based on the block-encrypted M-bit output of the parallel processor 120, and converting the plaintext into the ciphertext based on the block-encrypted M-bit output.

In this instance, each of the repetition processors 160 sequentially and repeatedly performs a process of dividing the block-encrypted M-bit output of the parallel processor 120 into at least two N-bit inputs, block-encrypting each of the divided N-bit inputs into each of M-bit outputs, and subsequently converting the plaintext into the ciphertext based on each of the block-encrypted M-bit outputs.

In this instance, each of the repetition processors 160 sequentially and repeatedly performs a process of block-encrypting the N-bit input into the M-bit output by using only the N-bit input length from within the block-encrypted M-bit output length of the parallel processor 120, and converting the plaintext into the ciphertext based on the block-encrypted M-bit output.

As described above, the encryption apparatus according to an exemplary embodiment of the present invention is operated in an output feedback (OFB) mode.

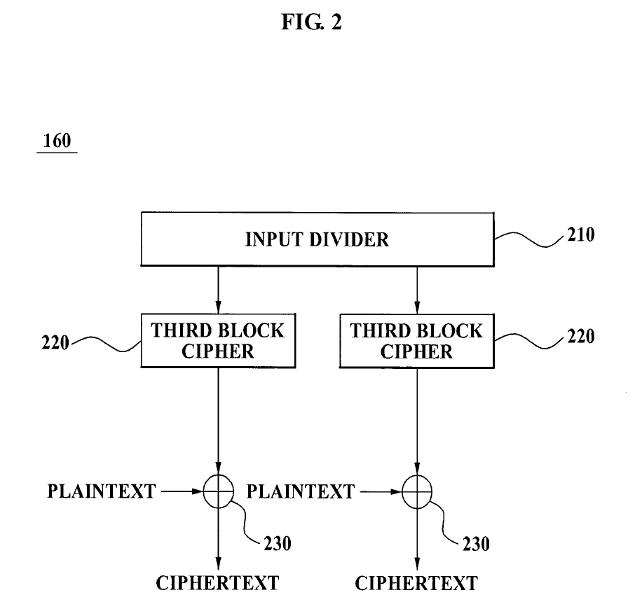

FIG. 2 is a block diagram illustrating a detailed configuration according to an exemplary embodiment of the repetition processor 160 of FIG. 1.

Referring to FIG. 2, the repetition processor 160 includes an input divider 210, third block ciphers 220, and converters 230.

The input divider 210 performs the same function as the function of the input divider 130 of FIG. 1.

Specifically, the input divider 210 divides the M-bit output block-encrypted by the second block cipher 150 into the N-bit inputs.

Each of the third block ciphers 220 block-encrypts each of the N-bit inputs divided by the input divider 210 into each of M-bit outputs.

In this instance, the third block cipher 220 may be the same as the first block cipher 110 or the second block cipher 150.

Each of the converters 230 converts a plaintext into a ciphertext based on the M-bit output block-encrypted by the third block cipher 220.

The repetition processor 160 of FIG. 2 is repeatedly configured in the output end of the third block cipher 220. The repetition processor 160 sequentially and repeatedly performs a process of dividing the block-encrypted M-bit output into at least two N-bit inputs, block-encrypting each of the divided N-bit inputs into each of M-bit outputs, and subsequently converting the plaintext into the ciphertext based on the block-encrypted each of M-bit outputs.

Specifically, as the repetition processor 160 repeats processing for each operation, an encryption processing speed becomes twice as fast. As the repetition processor 160 repeats for each n-number of operations, the encryption process speed becomes 2 n times as fast.

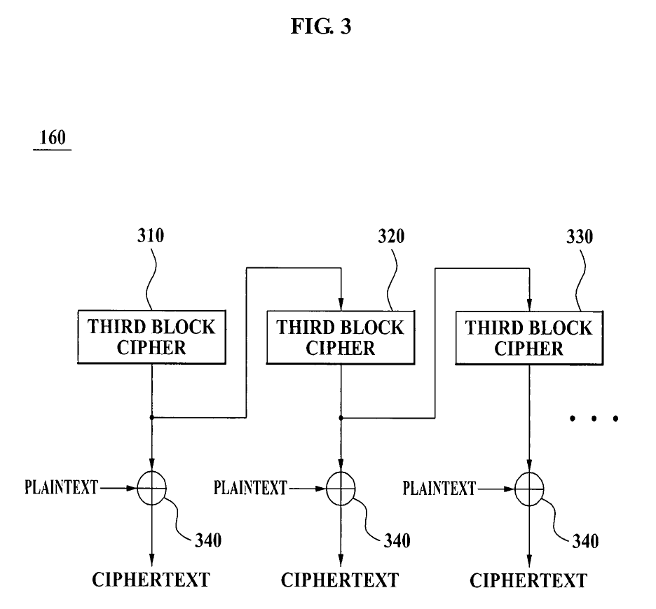

FIG. 3 is a block diagram illustrating a detailed configuration according to another exemplary embodiment of the repetition processor of FIG. 1.

Referring to FIG. 3, the repetition processor 160 includes third block ciphers 310 through 330, and converters 340.

Each of the third block ciphers 310 through 330 receives only N-bits from an M-bit output of either the second block cipher 150 or the third block cipher 310, and block-encrypts each of the N-bit inputs into each of M-bit outputs.

Specifically, a first of the third block ciphers 310 discards the remaining bits excluding the N-bits from an M-bit output of the second block cipher 150, and block-encrypts an N-bit input into an M-bit output.

A second of the third block ciphers 320 discards the remaining bits excluding the N-bits from an M-bit output of the first of the third block ciphers 310, and block-encrypts the N-bit input into the M-bit output.

A third of the third block ciphers 330 discards the remaining bits excluding the N-bits from an M-bit output of the second of the third block ciphers 320, and block-encrypts the N-bit input into the M-bit output.

In this instance, the third block ciphers 310 through 330 may be same as the first block cipher 110 or the second block cipher 150.

Each of the converters 340 converts a plaintext into a ciphertext based on the M-bit output block-encrypted by the third block cipher.

Here, each of the converters 340 sequentially converts the plaintext into the ciphertext based on the M-bit output.

Specifically, each of the converters 340 sequentially and repeatedly performs a process of converting the plaintext into the ciphertext based on the M-bit output block-encrypted by the first of the third block ciphers 310, converting the plaintext into the ciphertext based on the M-bit output block-encrypted by the second of the third block ciphers 320, and sequentially converting the plaintext into the ciphertext based on the M-bit output block-encrypted by the third of the third block ciphers 330. The above-described process is performed by all the third block ciphers and all the converters included in the repetition processor 160.

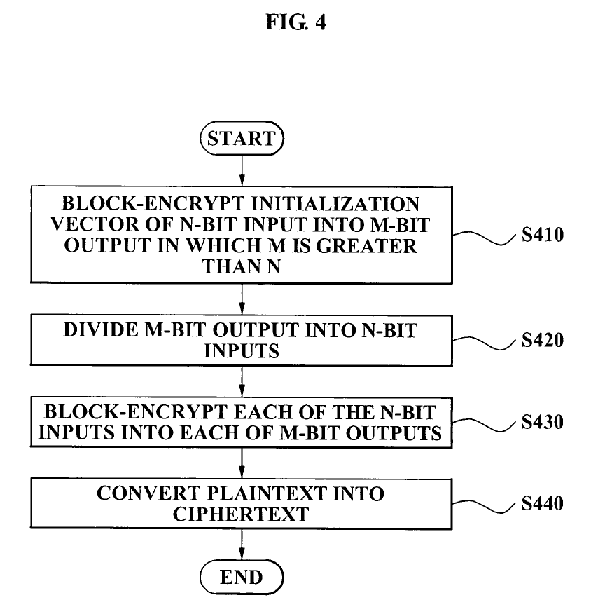

FIG. 4 is a flowchart illustrating operations of an encryption method according to an exemplary embodiment of the present invention.

Referring to FIG. 4, the encryption method block-encrypts, by a first block ciper, an initialization vector of an N-bit input into an M-bit output in which M is greater than N, in operation S410.

In this instance, a plaintext is converted into a ciphertext based on the block-encrypted M-bit output.

The M-bit output block-encrypted by the first block cipher is divided into N-bit inputs in operation S420.

In this instance, the M-bit output is divided into the N-bit inputs corresponding to multiple of an N-bit input length when an M-bit output length corresponds to the multiple of the N-bit input length.

In this instance, the M-bit output is divided into the N-bit inputs by using a padding method when the M-bit output length is different from the multiple of the N-bit input length. Specifically, bits remaining after dividing the M-bit output into N-bit inputs is generated into the N-bit input by using a padding method when the M-bit output length of the block cipher is different from the multiple of the N-bit input length.

In this instance, the bits remaining after dividing the M-bit is discarded when the M-bit output length is different from the multiple of the N-bit input length. For example, when the N-bit input length is 128-bits and the M-bit output length is 320-bits, 320-bits become two 128-bits and the remaining 64-bits are discarded. Accordingly, the M-bit output length 320-bits are divided into two N-bit input lengths.

Each of the N-bit inputs is block-encrypted into each of M-bit outputs by a parallel process which uses second block ciphers corresponding to a number of the divided N-bit inputs when the M-bit output is divided into N-bit inputs, in operation S430.

Specifically, each of two N-bit inputs is block-encrypted into each of two M-bit outputs by the parallel process which uses two second block ciphers when the M-bit output is divided into two N-bit inputs.

In this instance, the second block cipher may be same as the first block cipher.

Plaintexts are converted into ciphertexts by the parallel process, based on each of M-bit outputs block-encrypted by the second block ciphers, in operation S440.

For example, when the block-encrypted M-bit outputs are two, each of two plaintexts is processed by the parallel process based on each of M-bit outputs and is converted into two ciphertexts.

The encryption method according to an exemplary embodiment of the present invention is operated in an OFB mode.

In this instance, each of M-bit outputs block-encrypted in operation S430 is repeatedly performed by operations S420 through S440.

Specifically, a process of dividing the block-encrypted M-bit output into at least two N-bit inputs, block-encrypting each of the divided N-bit inputs into each of M-bit outputs, and subsequently converting the plaintext into the ciphertext, based on each of the block-encrypted M-bit outputs, is repeatedly performed.

In this instance, each of M-bit outputs block-encrypted in operation S430 sequentially and repeatedly performs a process of block-encrypting the N-bit input into the M-bit output by using only the N-bit input length from within the M-bit output length, and converting the plaintext into the ciphertext based on the block-encrypted M-bit output.

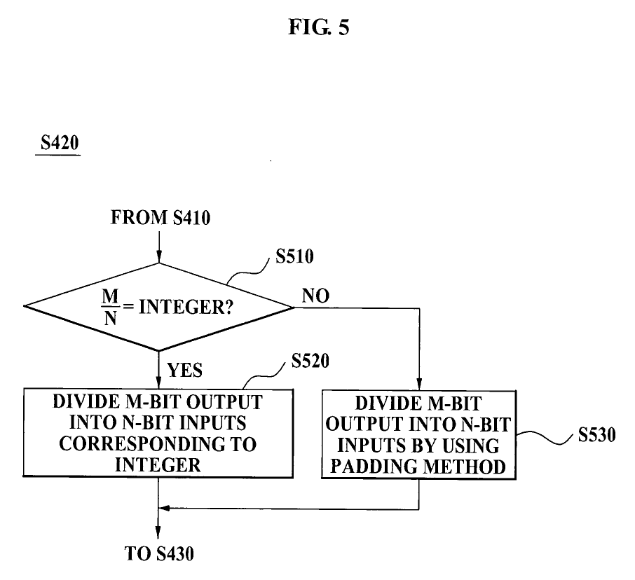

FIG. 5 is a flowchart illustrating operation S420 of FIG. 4 in detail according to an exemplary embodiment of the present invention.

Referring to FIG. 5, operation S420 of the dividing the M-bit output into the N-bit inputs determines whether an M-bit output length corresponds to a multiple of an N-bit input length, in operation S510.

Specifically, operation S420 determines whether a ratio of the M-bit output length and the N-bit input length corresponds to an integer.

The M-bit output is divided into the N-bit inputs corresponding to the multiple of the N-bit input length when the M-bit output length corresponds to the multiple of the N-bit input length resulting from operation S510 of the determining, in operation S520.

For example, the M-bit output is divided into two N-bit inputs when the M-bit output length corresponds to a double of the N-bit input length.

Conversely, the M-bit output is divided into the N-bit inputs by using a padding method when the M-bit output length is different from the multiple of the N-bit input length resulting from operation S510 of the determining, in operation S530.

Specifically, bits remaining after dividing the M-bit output length as many as the multiple corresponding to the N-bit input length from within the M-bit output length is generated into the N-bit input length by using the padding method, and the M-bit output is divided into the N-bit inputs.

The encryption method according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an exemplary embodiment of the present invention, there is provided an encryption apparatus and method which can efficiently process an encryption algorithm having an output length greater than an input length.

Also, according to an exemplary embodiment of the present invention, there is provided an encryption apparatus and method which can perform a parallel process of a ciphertext and improve encryption speed.

While certain exemplary embodiments of the present invention have been shown and described herein with reference to certain preferred embodiments thereof, it will be understood by those skilled in the art that various changes in form and detail may be made therein without departing from the spirit and scope of the invention as defined by the appended claims and their equivalents.

What is claimed is:

1. An encryption apparatus comprising:
a first block cipher which block-encrypts an N-bit input into an M-bit output in which M is greater than N;
a parallel processor which divides the M-bit output into at least two N-bit inputs, and block-encrypts each of the N-bit inputs into each of M-bit outputs by a parallel process which uses second block ciphers corresponding to a number of the divided N-bit inputs; and
a converter which converts a plaintext into a ciphertext based on the block-encrypted M-bit output.

2. The apparatus of claim 1, wherein the parallel processor comprises:
an input divider which divides the M-bit output into the N-bit inputs; and
an encrypter which block-encrypts each of the N-bit inputs into each of M-bit outputs by the parallel process for using the second block ciphers.

3. The apparatus of claim 1, wherein an M-bit output length of the block cipher corresponds to a multiple of an N-bit input length.

4. The apparatus of claim 1, wherein an M-bit output length of the block cipher is different from a multiple of an N-bit input length.

5. The apparatus of claim 4, wherein the parallel processor processes the M-bit output length into the multiple of the N-bit input length by using a padding method.

6. The apparatus of claim 5, wherein the parallel processor divides the N-bit input processed by the padding method into any one of the second block ciphers.

7. The apparatus of claim 1, wherein the first block cipher receives an N-bit initialization vector and block-encrypts the initialization vector into the M-bit output.

8. The apparatus of claim 1, wherein the encryption apparatus is operated in an output feedback (OFB) mode.

9. An encryption method comprising the steps of:
block-encrypting, by a first block cipher, an N-bit input into an M-bit output in which M is greater than N;
dividing the M-bit output into at least two N-bit inputs;
block-encrypting each of the N-bit inputs into each of M-bit outputs by a parallel process which uses second block ciphers corresponding to a number of the divided N-bit inputs; and
converting a plaintext into a ciphertext based on the block-encrypted M-bit output.

10. The method of claim 9, wherein an M-bit output length of the block cipher corresponds to a multiple of an N-bit input length.

11. The method of claim 9, wherein an M-bit output length of the block cipher is different from a multiple of an N-bit input length.

12. The method of claim 11, wherein the dividing processes the M-bit output length into the multiple of the N-bit input length by using a padding method.

13. The method of claim 12, wherein the dividing divides the N-bit input processed by the padding method into any one of the second block ciphers.

14. The method of claim 9, wherein the first block cipher receives an N-bit initialization vector, and block-encrypts the initialization vector into the M-bit output.

15. The method of claim 9, wherein the encryption method is operated in an OFB mode.

16. A computer-readable recording medium storing a program for implementing an encryption method, comprising:
a first set of instruction for block-encrypting, by a first block cipher, an N-bit input into an M-bit output in which M is greater than N;
a second set of instructions for dividing the M-bit output into at least two N-bit inputs;
a third set of instructions for block-encrypting each of the N-bit inputs into each of M-bit outputs by a parallel process which uses second block ciphers corresponding to a number of the divided N-bit inputs; and
a fourth set of instructions for converting a plaintext into a ciphertext, based on the block-encrypted M-bit output.
